(19) United States
(12) Patent Application Publication
(10) Pub. No.: US 2004/0109326 A1
(43) Pub. Date: Jun. 10, 2004

(54) Lighting and signaling device for motor vehicles or airplanes

(76) Inventor: Stefan Uhl, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/468,859

(22) PCT Filed: Jan. 23, 2002
(86) PCT No.: PCT/EP02/00631

(30) Foreign Application Priority Data
Feb. 24, 2001 (DE) 10109047.1

(51) Int. Cl. G02B 6/00

(52) U.S. Cl. 362/551; 362/558; 362/470

(57) ABSTRACT

The invention relates to a lighting and signaling device for vehicles or aircraft, having a light source and means for concentrating the radiation from this source onto the entrance end of a transparent rod, the. rod extending along a longitudinal axis A and having obliquely relative to the longitudinal axis a plurality of reflecting facets at which light emerges at a specific intensity, the facets cooperating optically with optical lenses which are arranged at the exit of an optical conductor rod in the path of the elementary light bundles reflected by the facets, light-controlling elements being provided which permit the deflection or passage of light by changing the reflection at the facet.

It is provided according to the invention that for the purpose of the passage of light a coupling element can be inserted into the beam path of the coupled-out beam in order to couple the beam in again.

The invention relates to a lighting and signaling device for vehicles or aircraft in accordance with the generically determinative features of claim 1.

The lighting and signaling device of the generic type is disclosed in DE 196 13 211 A1. This device has a light source whose light is focused into an optical rod. At specific points, light is coupled out of the rod by means of reflecting facets and guided by optical lenses onto the desired lighting field. The longitudinal axis of the optical conductor forms an acute angle relative to the facets, the inclination of the facets being dimensioned such that total reflection occurs at the facets. In DE 199 31 008, which is not a prior publication, it is disclosed how changes in the light distribution can be achieved. In order to influence the light distribution, it is conceivable for there to be present [lacuna] the light transmission controllable elements which are fitted, for example, between the light source and rod or upstream of the respective lens. A deflection of light or a passage of light is performed depending on the control state of the light-controlling element, and so a change in the light distribution surface on the road is performed in this way. The light-controlling element is inserted at an oblique angle into the part of the optical conductor that illuminates the facet, The light-controlling element interrupts the optical conductor rod by gaps at a small spacing. Formed at the first break point is a new facet at which the light is deflected in another direction by total reflection. The gaps are closed by joining the element to the optical conductor rod at both ends. Since the light-controlling element has a similar optical density to that of the optical conductor, no further interface reflection occurs. The light can pass along the rod through the element in an undiminished fashion, and light the original facet.

In the case of this type of signaling and lighting device, it is disadvantageous that it is difficult to produce an optical contact, In order to produce an optical contact, there is usually a requirement for a connecting medium that joins the two optical conductors so closely that an optical contact is produced. Another possibility is for the optical conductor rods to consist of an elastic material so that they can easily be pressed against one another so that an optical contact is produced.

The object of the invention is to improve a compact headlamp with variable light distribution such that the light distribution can easily be realized.

According to the invention, the object is achieved by the features of claim 1. Advantageous refinements and developments of the subject matter of the invention are characterized by the features of the subclaims.

A substantial advantage of these refinements consists in that the variable light distribution is achieved in a simple way in the case of a headlamp with the aid of optical conducting technology, light being coupled out from one optical conductor rod and coupled again into another optical conductor rod, and a variable light distribution of the headlamp light thereby being realized. The light intensity and the color can also be varied by suitable arrangements.

The invention is explained in more detail with the aid of an exemplary embodiment in conjunction with descriptions of the figures, in which:

FIG. 1 shows a diagrammatic illustration of a vehicle lighting unit with an optical conductor system,

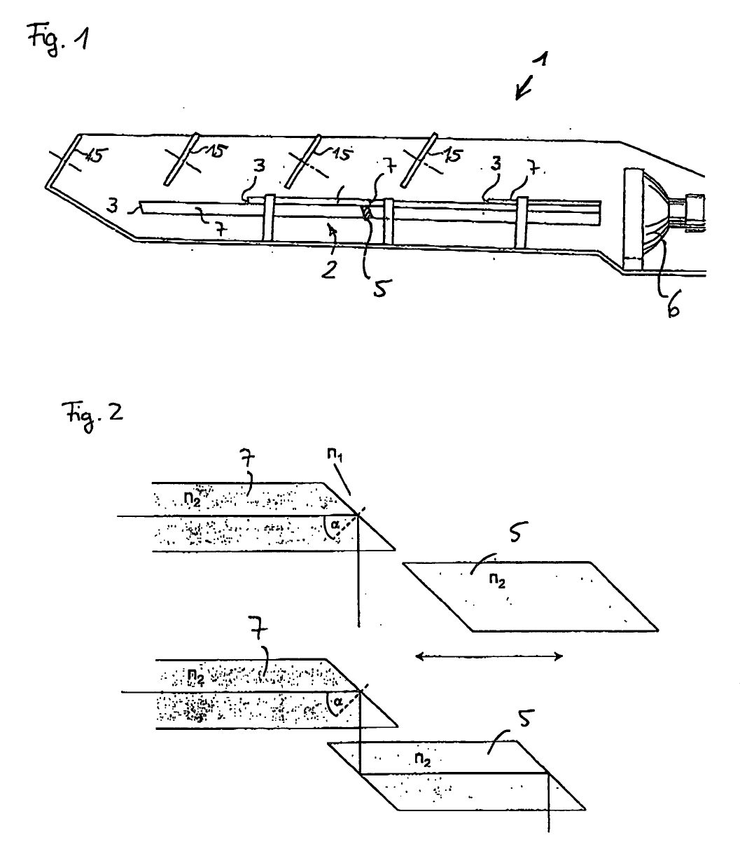

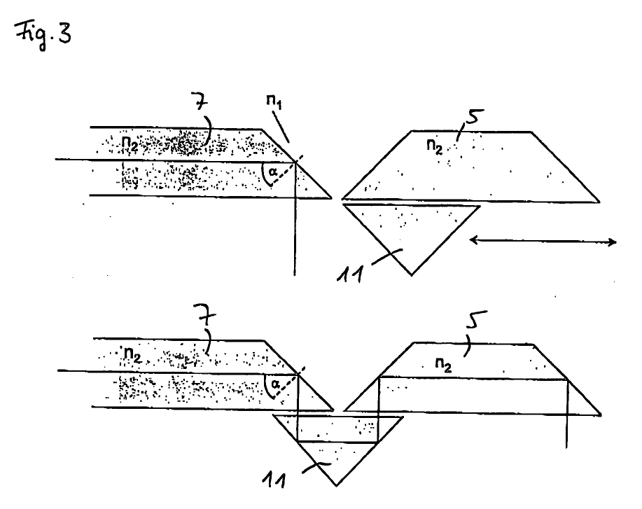

FIG. 2 shows a section of an optical conductor rod with an optical conductor rod which can be coupled on in a translatory fashion, and

FIG. 3 shows a section of an optical conductor rod with a coupling element which can be moved in a translatory fashion.

FIG. 1 shows a diagrammatic illustration of a vehicle lighting unit 1 with an optical conductor system, in particular for a headlamp of a vehicle or aircraft, the vehicle lighting device 1 having a light source 6 which couples the light into an optical rod 2. The light is passed on by the optical rod 2, constructed from optical conductors 7, is reflected at the facets 3, the facets cooperating with optical lenses 15 which are arranged at the exit of an optical conductor 7 in the path of the elementary light bundles reflected by the facets 3, and subsequently emerges from the optical conductors 7. The light-controlling elements 5 can be integrated into the optical conductor 7 and/or be connected directly on or at the facet 3. Depending on the control state of the light-controlling element 5, light is deflected or passes through, such that the light distribution surface on the road is changed in this way. The various light distribution surfaces form the headlamp light. For the purpose of the passage of light a coupling light can be inserted into the beam path of the coupled-out beam in order to couple the beam in again, Thus, various headlamp settings can be implemented by the correct connection. The light distribution on the road can be controlled as the situation demands using this control mechanism. A cornering light which adapts itself to the road in accordance with the bend, or else a headlamp control which uses local information from satellite navigation systems can be implemented simply and accurately thereby. In order to control the headlamp light, a control unit is provided which controls the light transmission and light absorption or light reflection of the light-controlling elements so as to produce a prescribed light distribution on the road.

FIG. 2 shows a section from an optical conductor rod 7 with an optical conductor rod 5 that can be coupled on in a translatory fashion. The two optical conductor rods 5, 7 have boundary surfaces which about light is not coupled from the first optical conductor rod 7 into the second optical conductor rod 5 via an optical contact of the two optical conductor rods 5, 7. The two optical conductor rods 5, 7 do not touch one another. The passage of light is performed by translatory parallel displacement of one of the two optical conductor rods 5, 7 as coupling element into the beam path of the beam coupled out from the other optical conductor rod. The light couples out of the first optical conductor rod 7 and enters the air or the medium surrounding the optical conductor rod 7 before it once again strikes the second optical conductor rod 5 and is coupled into the second optical conductor rod 5. The light traverses the first optical conductor rod 7 until it strikes the inclination, which has the angle of total reflection. At this inclination, the light is deflected downward in the z-direction and, after traversing the optical conductor, leaves the first optical conductor rod 7 and enters the medium surrounding the optical conductor rod 7. The light moves in this medium until it strikes the second optical conductor rod 5, into which it is coupled and is reflected again at an inclination which has the angle of total reflection into the desired direction of propagation in which it propagates. The second optical conductor rod 5 is arranged in a spatially offset fashion and is moved in a translatory fashion below or next to the first optical conductor rod 7 until the light coupled out from the first optical conductor rod 7 can be coupled again into the first optical conductor rod 7. Light is then passed on through the second optical conductor rod 5. The larger the overlap region of the two optical conductor rods 5, 7, the greater is the quantity of light that is passed on. The light intensity is set via the size of the overlap regions.

FIG. 3 shows a section from an optical conductor rod 7 having a coupling element 11 that can be moved in a translatory fashion. The two optical conductor rods 5, 7 are arranged in a stationary fashion, the light coupled out of the optical conductor rod 7 being reflected by a coupling element 11 and coupled into the optical conductor rod 5, the passage of light being performed by translatory parallel displacement of the coupling element 11. The two optical conductor rods 5, 7 are fixedly arranged at a suitable spacing from one another. The coupling element 11 can be moved into the light path such that the light coupled out from the first optical conductor rod 7 is reflected into the second optical conductor rod 5 via the coupling element 11. The first optical conductor rod 7 has an inclined surface that reflects the light downward, where the light leaves the optical conductor rod 7. If the coupling element 11 is located in this beam path, the light is coupled into the coupling element 11 and reflected such that the light emerges again at another point and can be coupled into the second optical conductor rod 5. In the second optical conductor rod 5, the light is reflected further in the desired direction of propagation and then passed on. At least two optical conductor rods 5, 7 and at least one coupling element 11 are provided in this case. However, it is also possible to provide more coupling elements along two optical conductor rods, or more than two optical conductor rods and a plurality of coupling elements 11 are provided.

In the arrangements of FIG. 2 and FIG. 3, the color of the headlamp light can be varied by coloring the second optical conductor rod. The second optical conductor rod is then colored in accordance with the desired color of the light.

1. A lighting and signaling device for vehicles or aircraft, having a light source (6) and means for concentrating the radiation from this source onto the entrance end of a transparent rod (2), the rod (2) extending along a longitudinal axis A and, having obliquely relative to the longitudinal axis (A) a plurality of reflecting facets (3) at which light emerges at a specific intensity, the facets (3) cooperating optically with optical lenses (15) which are arranged at the exit of an optical conductor rod (7) in the path of the elementary light bundles reflected by the facets (3), light-controlling elements (5) being provided which permit the deflection or passage of light by changing the reflection at the facet (3), characterized in that for the purpose of the passage of light a coupling element (11) can be inserted into the beam path of the coupled-out beam in order to couple the beam in again.

2. The lighting and signaling device for vehicles or aircraft as claimed in claim 1, characterized in that the passage of light is performed by translatory displacement of one of the two optical conductor rods (5, 7) as coupling element (11) into the beam path of the beam coupled out of the other optical conductor rod.

3. The lighting and signaling device for vehicles or aircraft as claimed in claim 2, characterized in that the two optical conductor rods (5, 7) are arranged in a stationary fashion, the light coupled out of the optical conductor rod (7) being reflected by a coupling element (11) and coupled into the optical conductor rod (5), the passage of light being performed by translatory parallel displacement of the coupling element (11).

4. The lighting and signaling device for vehicles or aircraft as claimed in claim 1, characterized in that the light intensity is performed via the size of the overlap region.

5. The lighting and signaling device as claimed in claims 1 to 4, characterized in that in order to change the color of the light the optical conductor rod (5) into which the light is coupled is colored in the color of the desired light.

6. The lighting and signaling device as claimed in claims 2 and 3, characterized in that at least two optical conductor rods (5, 7) and at least one coupling element (11) are provided.
